(19) United States
(12) Patent Application Publication
(10) Pub. No.: US 2007/0279441 A1
(43) Pub. Date: Dec. 6, 2007

(54) Ink Management Information System

(76) Inventor: Frederick Herbert Spohr, Milton (CA)

Correspondence Address: DIMOCK STRATTON LLP, 20 QUEEN STREET WEST SUITE 3202, BOX 102, TORONTO, ON, M5H 3R3, CA

(21) Appl. No.: 10/589,242

(22) PCT Filed: Feb. 11, 2005
(86) PCT No.: PCT/CA05/00172

§ 371 Date: May 30, 2007

(30) Foreign Application Priority Data
Feb. 13, 2004 (CA) 2,457,692

(51) Int. Cl. B41J 2/195

(52) U.S. Cl. 347/7

(57) ABSTRACT

A system for determining the weight of ink in an ink fountain in a printing press and having a sensor operatively connected to the ink fountain in order to measure the weight of the ink and to generate a signal corresponding to the ink weight, a processor that communicates with the sensor so as to receive and process the signal from the sensor and generates data about the weight of the ink contained in the ink fountain, a display in which the data relating to current ink usage at the ink fountain is displayed to an operator of the printing press. A method for determining the weight of ink in an ink fountain in a printing press consisting of the steps of measuring the weight of the ink using a sensor operatively connected to the ink fountain, generating a signal that corresponds to the generated weight, transmitting the signal to a processor and processing the signal to generate data about the weight of the ink and displaying the data relating to current usage at the ink fountain to an operator of the printing press. This system and method are simple in design, simple to implement and may be applied to any type of print discipline.

### FIELD OF THE INVENTION

The present invention relates to a system for determining the weight of ink in an ink fountain in a printing press by measuring, processing and displaying changes in the weight of ink contained in the ink fountain.

### BACKGROUND OF THE INVENTION

Annually, hundreds of thousands of tons of printing ink are provided to the printing industry without the ability to accurately measure the ink used within a printing press.

Ink usage at a printing press is usually measured by determining the weight difference between the ink before the print job is printed and the ink remaining after the job is completed. This information is then compiled for all print stations, all presses and all jobs printed. A monthly report is generated to show how much ink has been purchased, how much ink has been used and how much ink is left in inventory. This information is then used to determine the amount of money to be paid to ink suppliers and amount billed to the end-user.

This process of weighing the difference of ink before and after print is inaccurate because of the large error factor in converting total ink consumption to single impression usage, especially during four-colour (K.C.M.Y.), six-colour (hexachrome) or seven-colour (opaltone) process printing.

Today print shops need more precise information regarding actual ink usage or consumption per station, per design.

Some prior art systems that attempt to monitor ink usage in commercial printing presses rely on the re-routing of ink through elaborate storage systems (tanks, pumps, vessels) and on the measurement of ink-flow by means of mechanical levers, valves and coupling lines in conjunction with analog sensor technology. These prior art systems are press specific and adaptable only to one type of print discipline (for example, flexography or letterpress or lithography etc.) and deal only with an initial ink volume supplied to the press. These prior art systems also do not take into account the constant need for additional, manual press adds for colour, rheology, formulation or other related changes.

U.S. Pat. No. 4,921,132 by Wales teaches an ink flow monitoring system that monitors the ink flow from a storage tank to at least one ink fountain of a printing press. This system uses a scale to measure the weight of the ink storage tank and compares the weight signals from the scale at various times to determine the weight of the total ink consumed over the interval between readings. Wales utilizes calculations to provide an indirect estimate of the total ink weight consumption for each fountain in the printing press.

U.S. Pat. No. 5,777,634 to Okamura teaches an apparatus used for detecting the weight of an ink tank to determine the quantity of ink usage in a printer. In this invention, a slidable carriage carries, among other things, the ink tank. The carriage has a projection that communicates with a stationary sensor. The sensor detects the weight of the carriage including the weight of the ink tank and determines the weight of ink being consumed. The weight of the ink may be indirectly calculated based on the relative position of the carriage as the ink in the ink tank is being used.

Accordingly, there exists a need for a system that provides accurate information regarding the amount of ink used in a printing press and allows the operator to know where the ink was used and how it was modified during usage. Such information allows for the prediction of ink usage or consumption when costing out new print jobs or formulation updates at the ink laboratory. It gives designers the ability to build costing models around various print designs. Also there is a need for a system that is simple in design and easy to use. Preferably, such a system should be adaptable for use for all press designs in all print disciplines.

### SUMMARY OF THE INVENTION

The present invention overcomes the above-mentioned problems of inaccuracy, overly elaborate systems, and systems that are press specific and specific to a particular print discipline.

In one preferred embodiment of the present invention, sensors, for example load cells, are operatively connected to the ink fountain of a printing press. As a result, the present invention adapts the existing ink fountain of a printing press to a weigh station. There may be multiple printing stations on a printing press, with each printing station containing an ink fountain. Digital technology, such as wireless technology, sends a signal from the sensors to a processor that receives and processes the signal to generate data about the ink weight and changes in ink weight, as compared to the initial or “base” ink weight. This data is displayed on a display means such as an interactive touch screen console.

Unlike the prior art systems, the preferred embodiments of the present invention permit an operator of a printing press to:
a. determine current ink usage, per colour, per design;
b. determine ink usage for differing sets of circumstances such as, but not limited to, changes in press conditions, substrate, film thickness and graphic variability; and
c. allows for documentation of press-side additions by allowing the operator to enter new ingredients used in press-side adjustments, upgrade master formulations and print new container labels containing the updated data, all via an interactive display console.

Moreover, an important difference between the preferred system of the present invention and other prior art systems that monitor ink usage is the simplicity of the present invention. The preferred system of the present invention also has the advantage of being capable of being adapted and applied to various printing press designs and is compatible to all printing technologies such as lithography, letterpress, flexography etc.

One aspect of the present invention thus provides a system for determining a change in the weight of ink contained in an ink fountain in a printing press, said system comprising:
a. a sensor operatively connected to the ink fountain, wherein said sensor measures the weight of the ink and generates a signal corresponding to the measured weight;
b. a processor that is in communication with said sensor so as to receive and process the signal from said sensor and generate data about the weight of the ink contained in said ink fountain; and
c. a display in which the data is displayed to an operator of the printing press;
whereby the displayed data provides the operator of the printing press with information relating to current ink usage at said ink fountain.

A second aspect of the present invention provides a method for determining a change in the weight of ink contained in an ink fountain in a printing press, the method comprising of the steps of:
a. measuring the weight of the ink using a sensor operatively connected to the ink fountain;
b. generating a signal that corresponds to the measured weight;
c. transmitting the signal to a processor and processing the signal to generate data about the weight of the ink; and
d. displaying the data to an operator of the printing press;
whereby the displayed data provides the operator of the printing press with information relating to current ink usage at said ink fountain.

### BRIEF DESCRIPTION OF THE DRAWINGS

In drawings which illustrate by way of example only a preferred embodiment of the invention,

FIG. 1 is a schematic drawing of a lithographic printing press illustrating the placement of the sensors in accordance with one aspect of the present invention.

FIG. 2 is a schematic drawing of a rotogravure printing press illustrating the placement of the sensors in accordance with a second aspect of the present invention.

FIG. 3 is a schematic drawing of a printing press with multiple ink fountains illustrating the placement of the sensors and communication with the processor in accordance with a further aspect of the present invention.

### DETAILED DESCRIPTION OF THE PREFERRED EMBODIMENTS

The preferred embodiment of the present invention is utilized to provide the operator of the printing press with data on ink usage at each ink fountain in a printing press. In response to data such as changes in press conditions, substrate film thickness and graphic variability, the appropriate press-side adjustments may be made.

In printing presses, the ink is transferred to the substrate at the ink fountain. Accordingly, in the preferred embodiment of the present invention, sensors, for example load cells, are operatively connected to the ink fountains in order to measure the weight of the ink contained in the ink fountains and the sensors generate signals corresponding to the measured weight. In effect, the existing ink fountain in a printing press is adapted or converted to a weigh station.

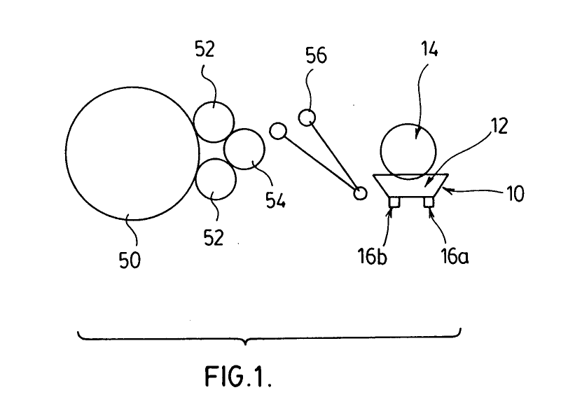

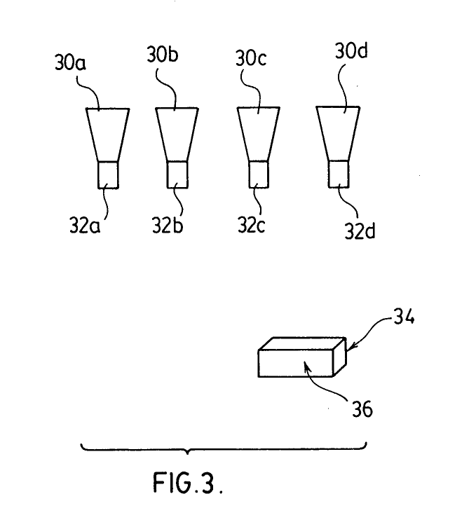

FIG. 1 is a schematic drawing of a lithographic printing press modified in accordance with one aspect of the present invention. The plate cylinder 50, damping form roller 52, vibrator 54, and ductor 56 are all shown. The ink fountain 10 contains ink 12. Some of the ink 12 is transferred to the fountain roller 14 and as a result the weight in the ink fountain 10 is reduced. Sensors 16a and 16b are placed on the underside of the ink fountain 10 to measure the weight of the ink 12 and the ink fountain 10 at any given time. The sensors 16a and 16b generate signals corresponding to the measured weight and these signals are transmitted to, received and processed by a processor 34 (not shown in FIG. 1 but shown in FIG. 3). Weight measurements taken at different times at a particular ink fountain 10 will reflect changes in the weight of the ink 12 contained in that particular ink fountain 10 as the ink 12 is consumed during the printing process.

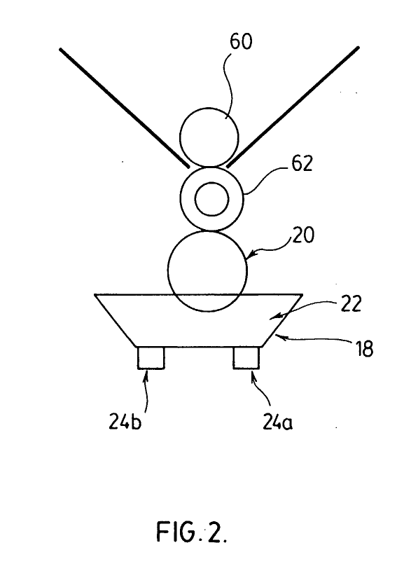

Similarly, FIG. 2 illustrates the placement of sensors 24a and 24b in a rotogravure printing press. The ink fountain 18 contains ink 22. During ink usage, some of the ink 22 is transferred to the roller 20, thus reducing the weight of the ink 22 in the ink fountain 18. Sensors 24a and 24b are placed on the underside of the ink fountain 18 so as to measure changes in the weight of the ink 22 contained in the ink fountain 18 during ink usage. The impression roller 60 and the print cylinder 62 are also shown in FIG. 2.

In FIGS. 1 and 2, the sensors 16a, 16b, 24a and 24b are shown placed on the underside of the ink fountains 10 and 18. However, the placement of the sensors are not necessarily limited to this location, but rather may be placed anywhere so as to be operatively connected to the ink fountains to measure changes in the weight of the ink contained in the ink fountain.

In a preferred embodiment of this invention the sensors 16a, 16b, 24a and 24b are load cells, but the sensors need not necessarily be limited to load cells. The preferred load cells are small enough in size so as not to interfere with the operation of the printing press. Several commonly available load cells may be used in the present invention, including but not limited to load cells manufactured by Transducer Techniques, AMTI, Strainsert, Copper Instruments and Systems, and Interface Load Cells.

The preferred system of the present invention consists of the basic elements of load cells operatively connected to ink fountains so as to measure the weight of the ink contained in the ink fountains and generate a signal corresponding to the measured weight, a computer processor in communication with the load cells so as to receive and process the signal from the load cells and generate data about the weight of the ink, use of a wireless infrared transmitter to communicate the signal from the load cells to the computer processor, and a touch screen display module to display to an operator the data relating to current ink usage.

Furthermore, programmed into the processor are relevant parameters relating to ink quantity, quality and composition programmed, as well as other relevant factors to the printing process such as, but not limited to, substrate composition. Each of the parameters programmed into the processor has a corresponding pad or other interactive means on a display used by an operator. In a preferred embodiment of the present invention, the display is an interactive touch screen. Each pad on the touch screen display for a given parameter is operatively connected to the processor such that any changes to a given parameter may be recorded in the processor by means of the operator inputting the parameter change on the touch screen display.

In further preferred embodiment of the present invention, the operator may modify various parameters in the ink formation at the site of the ink fountain itself by means of inputting the desired change on the interactive touch screen console.

FIG. 3 illustrates a further embodiment of the present invention. In FIG. 3, sensors 32a, 32b, 32c and 32d are placed under ink fountains 30a, 30b, 30c and 30d respectively. Sensors 32a-32d measure the weight of the ink and the ink fountains 30a-30d and generates a signal corresponding to the measured weight. The signals from these sensors are transmitted or otherwise relayed to a processor 34, such as a computer. The means of operation of sensors 32a-32d is well-known and commonly understood. The processor 34 receives and processes the signals from the sensors 32a-32d and generates data about the weight of the ink contained in each of the ink fountains 30a-30d. This data is then displayed on the interactive display, preferably a touch screen console 36. Such transmission of data from sensors to processor to display may be accomplished by various means including wireless, wired or digital technology, but wireless technology is preferred such as a wireless infrared transmitter. The resulting weight data displayed on the interactive display is a current account of the ink usage within each ink fountain 30a-30d.

In FIG. 3, each ink fountain 30a-30d may contain a different colour of ink. Accordingly, the resulting weight data is a current account of ink usage per ink colour. This information may be provided for each design printed.

The preferred system of the present invention overcomes the elaborate and complicated prior art ink management systems because, unlike the prior art systems, there is no need for bulky analog technology, tanks, pumps or other intrusive equipment to the press. Moreover, given that sensors may be placed on ink fountains in any printing press, the present invention may be used on various press designs in various printing disciplines including letterpress, lithography, flexography, rotogravure, primography, rotary screen, and intaglio.

If during a printing run the operator wants to know how much ink is being consumed, the operator would at the beginning of the run obtain the weight of ink in one or more ink fountains of interest. Relevant information such as the station, colour, ink container, batch number and weight of ink contained in said ink fountain(s) are recorded. The sensors at the ink fountain(s) constantly monitor the changes in ink weight as compared to the original beginning weight at each ink fountain. Such information is communicated to the processor to determine the current weight and current usage of ink. The current weight and current usage of ink at each ink fountain are in turn displayed on the interactive display screen to the operator or are otherwise accessible to the operator (for example, a paper printout of such information outputted from the said screen). Other relevant information such as the colour, identity of ink container, batch number are recorded in the processor and displayed to the operator.

Due to the factors of the printing process (friction, shear rate, absorption etc), printing ink varies in strength and colour. Thus, there is a need for the operator of a printing press to make press-side adjustments to the ink formulations.

The present invention allows for documentation of press-side adjustments by allowing the operator to interact with the system via the touch screen console in order to enter new ingredients into computer master database, print new container labels for ink that has been purposely adjusted during the printing process and upgrade master formulations.

Formulation changes such as colour adjustments or press-side additive adjustments such as for wax, are made by adding ingredients to the ink in the ink fountain. In making such adjustments, the operator would activate the “tare weight” of the sensor, in this particular embodiment, a load cell, to zero. In a preferred embodiment of the present invention, the operator would then select the button on the touch screen console for that ingredient, add the new ingredient or add or delete an existing ingredient from the ink fountain. The new weight for the ink or other ingredient in the ink fountain would be measured and processed by the processor and be displayed on the touch screen console. The processor recalculates the ink formulation to include the adjustments and enters the new formulation into the master formula file which is stored in the processor.

The processor may be equipped with both hardware and software allowing for communication and data sharing between each print station in a local area network. The computer may store product code, batch and formulation data including health and safety updates and ink usage instructions for each item entered.

Finally, the preferred system of the present invention may be applied to manage the flow of ink related information between ink stations, ink rooms, and head offices through, but not limited to, Web-based, Ethernet, Internet and local area networks. The management of the information flow includes processing and transmission of up-to-date data allowing for forecasting and profitability applications as well as ink movement analysis on a regional or product group basis.

As a result, ink manufacturers can perform global formulation updates as patterns evolve while inventories can be managed on a regional or global level, based on identification technology such as but not limited to barcode scanning identification technology.

A further aspect of the present invention is a method for determining changes in the weight of ink contained in an ink fountain in a printing press. The first step in this method is to measure the weight of the ink using a sensor operatively connected to the ink fountain. In a preferred embodiment of the present invention, the senor is a load cell. The second step is for the sensor to generate a signal that corresponds with the measured weight of ink. The third step is for the signal to be transmitted to a processor which processes the signal to generate data about the weight of the ink. In a preferred embodiment of the present invention, the processor is a computer. The fourth step is for the data generated by processor to be displayed to an operator of the printing press. The displayed data provides the operator with information relating to current ink usage at the ink fountain. In a preferred embodiment of the present invention, the data displayed to the operator is on a touch screen console. This same method is applicable when the printing press contains two or more ink fountains. In such circumstances, the weight of the ink in each of the ink fountains is measured by using at least one sensor operatively connected to each ink fountain.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A system for determining a change in the weight of ink contained in an ink fountain in a printing press, said system comprising:
a. a sensor operatively connected to the ink fountain, wherein said sensor measures the weight of the ink and generates a signal corresponding to the measured weight;
b. a processor that is in communication with said sensor so as to receive and process the signal from said sensor and generate data about the weight of the ink contained in said ink fountain; and
c. a display in which the data is displayed to an operator of the printing press;
whereby the displayed data provides the operator of the printing press with information relating to current ink usage at said ink fountain.

2. The system of claim 1 wherein said sensor communicates with said processor by means of a wireless or wired device or network.

3. The system of claim 1 wherein said sensor is a load cell.

4. The system of claim 3 wherein said processor is a computer.

5. The system of claim 4 wherein said display is a touch screen console.

6. The system of claim 1 wherein said printing press comprises two or more ink fountains, and the system comprises at least one sensor operatively connected to each ink fountain.

7. The system of claim 6 wherein each of the ink fountains contains ink of different colors, and the data is displayed to the operator on a per colour basis for each ink fountain.

8. A method for determining a change in the weight of ink contained in an ink fountain in a printing press, the method comprising of the steps of:
a. measuring the weight of the ink using a sensor operatively connected to the ink fountain;
b. generating a signal that corresponds to the measured weight;
c. transmitting the signal to a processor and processing the signal to generate data about the weight of the ink; and
d. displaying the data to an operator of the printing press;
whereby the displayed data provides the operator of the printing press with information relating to current ink usage at said ink fountain.

9. The method of claim 8 wherein said sensor transmits the signal to the processor by means of a wireless or wired device or network.

10. The method of claim 8 wherein said sensor is a load cell.

11. The method of claim 10 wherein said processor is a computer.

12. The method of claim 11 wherein said display is a touch screen console.

13. The method of claim 8 wherein said printing press comprises two or more ink fountains, and the method comprises measuring the weight of the ink in each of the ink fountains using at least one sensor operatively connected to each ink fountain.

14. The method of claim 13 wherein each of the ink fountains contains ink of different colors, and the displayed data is provided to the operator on a per colour basis.

15. The system of claim 1 wherein the display is an interactive display that allows the operator to make press-side adjustments to the system by using the interactive display, wherein the processor generates data about the press-side adjustments.

16. The system of claim 15 wherein the system comprises means for transmitting the press-side adjustments data to a third party.
